(19) United States
(12) Patent Application Publication
(10) Pub. No.: US 2008/0106834 A1
(43) Pub. Date: May 8, 2008

(54) ELECTROSTATIC DISCHARGE PROTECTION CIRCUIT

(76) Inventor: Kenneth Wai Ming Hung, Hong Kong (CN)

Correspondence Address: XIN WEN, 3449 RAMBOW DRIVE, PALO ALTO, CA, 94306, US

(21) Appl. No.: 11/557,488

(22) Filed: Nov. 7, 2006

(51) Int. Cl. H02H 9/04

(52) U.S. Cl. 361/56

(57) ABSTRACT

An electrostatic discharge protection circuit includes a first inverter, a first transistor having a gate connected with the output of the first inverter and a drain connected with the input of the first inverter, a second transistor having a gate connected with the output of the first inverter and a source connected with the input of the first inverter, and a shunting transistor configured to discharge electrostatic charges between a first terminal and a second terminal in response to the output of the first inverter.

### BACKGROUND

The present disclosure relates to an electrostatic discharge (ESD) protection circuit.

Electrostatic discharge is an event that can occur during device fabrication, assembly packaging, or device handling. During a typical ESD event, a large amount of charge is accumulated in a bonding pad of an integrated circuit. If the charges develop a high voltage that the chip cannot tolerate, a fatal discharge may happen inside the chip to cause the chip malfunction.

Conventional ESD protection circuits include grounded-gate NMOS (GGNMOS) and gate-coupled NMOS (GCNMOS). The GGNMOS ESD protection circuit includes an N-MOSFET transistor with gate connected to sources node to form a gate-connected diode. The GCNMOS ESD protection circuit include RC circuits that collect electrostatic charges during an ESD event. When the voltage of the capacitor exceeds a threshold, an N-MOSFET transistor is triggered to discharge the electrostatic charges. The RC values in these circuits are required to be quite large in order to provide sufficient on time for the N-MOSFET transistor to discharge the electrostatic charges.

FIG. 1 illustrates an example of a conventional GCNMOS ESD protection circuit. Circuit 1 includes a resistor R1, a capacitor C1, N-MOSFET transistors MN1 and MN2, and P-MOSFET transistor MP1. Two supply terminals 10 and 11 are respectively at voltages VDD and VSS. During an ESD event, positive charges accumulate at the supply terminal 10 and/or a negative charge is stored at the supply terminal 11. The transistor MN2 can shunt current to discharge electrostatic charges between supply terminals 10 and 11. The resistor R1 and the capacitor C1 are coupled in series to form an RC circuit between supply terminals 10 and 11. N-MOSFET transistor MN1 is a pull-down transistor having a gate coupled to node 5, a drain coupled to node 6, and a source coupled to the supply terminal 11. P-MOSFET transistor MP1 is a pull-up transistor having a gate coupled to node 5, a drain coupled to node 6, and a source coupled to the supply terminal 10. Transistors MP1 and MN1 form an inverter with an input at node 5 and an output at node 6. N-MOSFET transistor MN2 has a gate coupled to node 6, a drain coupled to the supply terminal 10, and a source coupled to the supply terminal 11.

Referring to FIG. 2, before an ESD event happens, all the nodes in circuit 1 can be considered to be at nearly an equal potential. For simplicity, the equal potential can be defined as the ground voltage. During and ESD event wherein the supply terminal 10 zaps to the supply terminal 11, a positive current flows into the supply terminal 10. An ESD voltage pulse at the supply terminal VDD can include a rise time of approximately 5.5 nanosecond and last for a period of approximately 400 nanosecond.

The voltage at node 5 is initially low. The voltage at the supply terminal 10 builds up. When the difference between VDD and the voltage at node 5 exceeds the threshold voltage of MP1, MP1 turns on and pulls node 6 high. With node 6 high, MN2 turns on and shunts current from supply terminal 10 to supply terminal 11. The voltage at node 5 gradually rises due to the charging of the capacitor C2 by the current flowing through R1. After approximately a time delay characterized by the RC constant and R1 and C1, the voltage at node 5 exceeds the threshold voltage of MN1 which turns MN1 on and pulls node 6 down, thus shutting down MN2 and stopping the current shunting at the transistor MN2.

The voltage timing diagrams at node 5 and node 6 are shown for a large RC value (dashed lines) and a small RC value (solid lines). A GCNMOS ESD protection circuit with a small RC value does not provide sufficient time for the discharge at the shunting transistor MN2. The circuit having a large RC value (approximately 400 ns) can allow the transistor MN2 to discharge the electrostatic charges during the almost full width of the ESD voltage pulse.

The large RC values, however, present several drawbacks in modern circuit designs. The large capacitors and capacitors in the conventional ESD protection circuit cannot be easily reduced in dimension as the rest of the chip devices are reduced. The inability for the conventional ESD protection circuit to scale down is particularly challenging in submicron size circuit designs. Moreover, large RC values can also affect the responsiveness to ESD events by the conventional ESD protection circuit and the power cycle time for a chip device. A large capacitor can store more charges during an ESD event. More time is thus needed to discharge the capacitor in a device power-off before the chip device can be powered up. The ESD protection circuit cannot properly start before the capacitor is properly discharged. Furthermore, a large RC value can make the conventional ESD protection circuit more susceptible to false discharge actions in response to normal voltage fluctuations in the voltage supply terminals.

### SUMMARY

In a general aspect, the present invention relates to an electrostatic discharge protection circuit including a first inverter; a first transistor having a gate connected with the output of the first inverter and a drain connected with the input of the first inverter; a second transistor having a gate connected with the output of the first inverter and a source connected with the input of the first inverter; and a shunting transistor configured to discharge electrostatic charges between a first terminal and a second terminal in response to the output of the first inverter.

In another general aspect, the present invention relates to an electrostatic discharge protection circuit including an RC circuit connected with a first terminal and a second terminal, wherein the RC circuit comprises a resistor and a capacitor; a first inverter having an input connected with the capacitor and the resistor; a fist transistor having a gate connected with the output of the first inverter and a drain or a source connect with the input of the first inverter; and a shunting transistor configured to discharge electrostatic charges between the first terminal and the second terminal in response to the output of the first inverter.

In yet another general aspect, the present invention relates to an electrostatic discharge protection circuit, including an RC circuit connected with a first terminal and a second terminal, wherein the RC circuit comprises a resistor and a capacitor; a first inverter having an input connected with the capacitor and the resistor; a second inverter having an input connected to the output of the first inverter; a third inverter having an input connected to the output of the second inverter; a first shunting transistor each having a gate connected with the output of the second inverter; and a second shunting transistor each having a gate connected with the output of the third inverter.

Implementations of the system may include one or more of the following. The electrostatic discharge protection circuit can further include an RC circuit including a resistor and a capacitor, wherein the resistor and the capacitor are connected to an input to the first inverter. The resistor and the capacitor can be serially connected. The resistor an the capacitor can be respectively connected with the first terminal and the second terminal. The first inverter can include an N-MOSFET transistor and a P-MOSFET transistor. The electrostatic discharge protection circuit can further include a second inverter having an input connected to the output of the first inverter and an output connected to the gate of the shunting transistor. The shunting transistor can be a P-MOSFET transistor. The electrostatic discharge protection circuit can further include a second inverter having an input connected to the output of the first inverter; and a third inverter having an input connected to the output of the second inverter and an output connected to the gate of the shunting transistor. The shunting transistor can be an N-MOSFET transistor.

Embodiments may include one or more of the following advantages. An advantage of the disclosed ESD protection circuit is that its designs allows the resistor and capacitors to be reduced in sizes while still providing extended discharge time in a ESD event, thus overcoming a key limitation in the conventional ESD protection circuit. Moreover, the small capacitance in the disclosed ESD protection circuit to more quickly discharge the capacitor during the device power-off, which allows the circuit to be more responsiveness to ESD events and power-off/on cycles.

The disclosed ESD protection circuit also provides reliability and stability during normal operations. In a normal operation, the voltage VDD at the supply terminal is fairly constant and stays high without large and fast fluctuations. The normal operations can include a power-up sequence in which the VDD rise to the high voltage takes a time period from 1 micron second to 1 second. The disclosed ESD protection circuit includes a feedback transistor that can keep the voltage at node 5 high and stable despite of voltage fluctuations at the supply terminal.

Another advantage of the disclosed ESD protection circuit is that electrostatic discharge can be realized by a P-MOSFET shunting transistor, a N-MOSFET shunting transistor, or a combination of a P-MOSFET and N-MOSFET shunting transistors. The disclosed ESD protection circuit also provides more flexibility in ESD protection circuit designs. The P-MOSFET shunting transistor can provide more uniform current distributions than the N-MOSFET shunting transistors in the conventional ESD protection circuits.

Furthermore, an effective and flexible pad circuit design for ESD protection circuit is disclosed. The pad circuit can protect the device from ESD zapping between different combinations of voltage supply terminals and a bonding pad. The disclosed ESD protection circuits and the pad circuit can be flexibly applied to many pad configurations and different pins and terminals in a chip device.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 is a schematic diagram of a conventional gate-coupled MNOS ESD protection circuit.

FIG. 2 illustrates the waveform of an electrostatic voltage and timing diagrams during an ESD event in the conventional gate-coupled NMOS ESD protection circuit.

FIG. 3 is a schematic diagram of an improved ESD protection circuit including an internal feedback circuit and an N-MOSFET shunting transistor.

FIG. 4 is a schematic diagram of an improved ESD protection circuit including an internal feedback circuit and a P-MOSFET shunting transistor.

FIG. 5 illustrates exemplified voltage waveforms at two nodes in the improved ESD protection circuit during a power-up period.

FIG. 6 illustrates exemplified voltage waveforms at two nodes during an ESD event in the improved ESD protection circuit.

FIG. 7 is a schematic diagram illustrating an implementation of the improved ESD circuit with a pad cell.

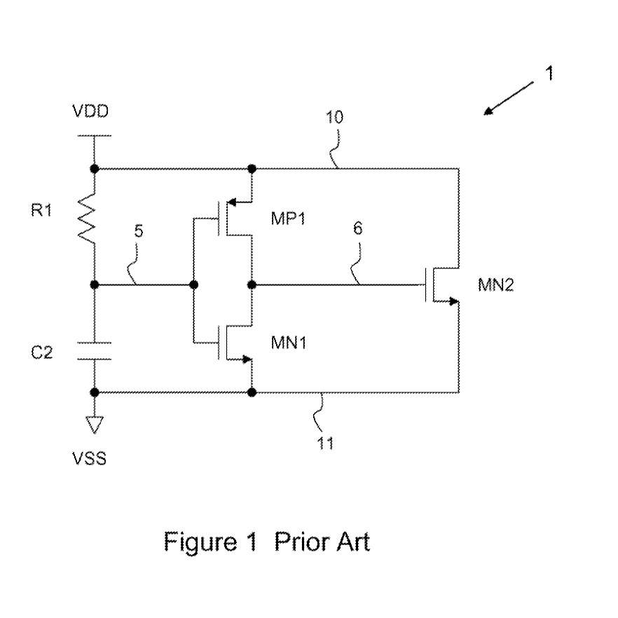

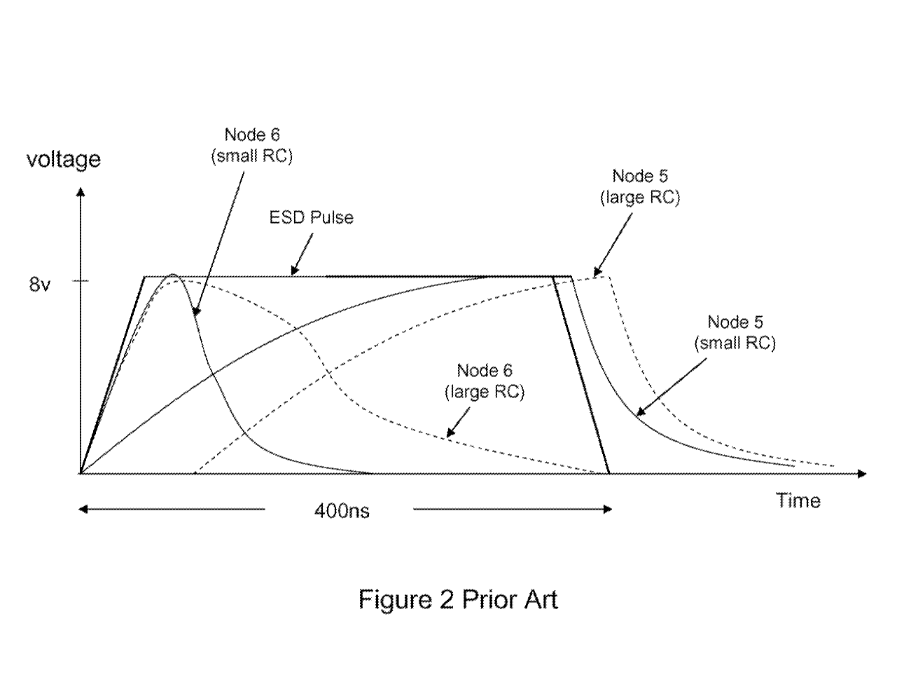

### DETAILED DESCRIPTION

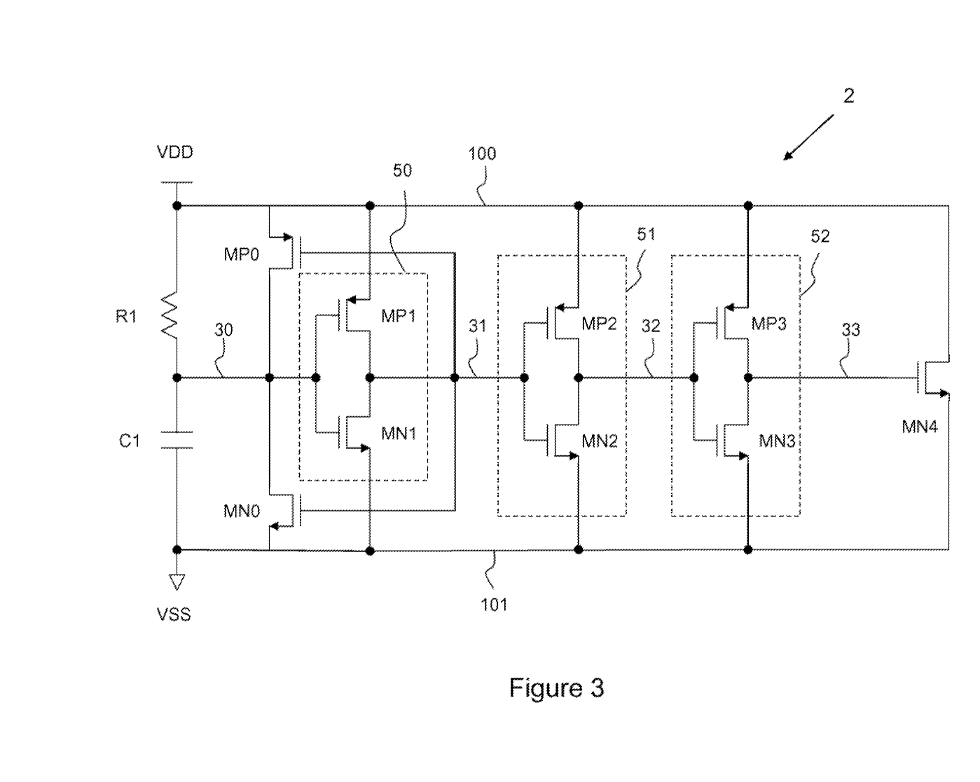

FIG. 3 illustrates a schematic diagram of an improved ESD protection circuit 2. Circuit 2 can be part of an electronic device such as a chip device that can include a plurality of terminals or pins for input and output, voltage supply, and ground connection. Circuit 2 is designed to protect the device from electrostatic charges at power-on (normal operation) state and power-off state. The ESD protection circuit 2 includes a resistor R1, a capacitor C1, a P-MOSFET transistor MP1, and an N-MOSFET transistor MN1. The resistor R1 and the capacitor C1 are serially connected at node 30 between the supply terminals 100 and 101 that are respectively at voltages VDD and VSS. The P-MOSFET transistor MP1 and the N-MOSFET transistor MN1 form an inverter 50 having an input at node 30 and an output at node 31. The threshold voltage for the inverter 50 is dependent on the difference between VDD and VSS, which can be VDD/2 if the transistors MP1 and MN1 symmetrically designed and VSS is at 0 voltage. Node 31 is further connected with two sequential inverters 51 and 52. The inverter 51 includes a P-MOSFET transistor MP2 and an N-MOSFET transistor MN2. The inverter 52 includes a P-MOSFET transistor MP3 and an N-MOSFET transistor MN3. The output of the inverter 52, node 33, is connected with the input of the shunting transistor MN4.

The circuit 2 includes a pair of feedback transistors: a P-MOSFET transistor MP0 and an N-MOSFET transistor NM0. The gates of the transistors MP0 and MN0 are both connected with node 31, the output of the inverter 50. The transistor MP0 includes a source connected to the supply terminal 100 and a drain connected to node 30, the input of the inverter 50. The transistor MN0 includes a source connected to node 30, the input of the inverter 50 and a drain connected to the supply terminal 101.

Before an ESD event happens, all nodes in the circuit 2 are considered to be at nearly equal potential that can be conveniently defined as zero voltage. During as ESD event, a positive current can flow into the supply terminal 100. Initially, node 30 is at a low voltage state. A current flows through the resistor R1 to charge the capacitor C1. A voltage builds up across the resistor R1. When the potential difference between the supply terminal 100 and node 30 exceeds the threshold voltage (which can be VDD/2 for example) of the transistor MP1, MP1 turns on and pulls node 31 to a high voltage state. The high voltage state at node 31 drives node 32 to a low-voltage state through the inverter 51, which in turn drives node 33 high through the inverter 52. The high voltage state at node 33 turns on MN4, thus discharging the electrostatic charges by the current along MN4's source-drain path at from the supply terminal 100 to the supply terminal 101.

The inverters 50 and 51 are used to sharpen the signal output from node 31 to provide a sharp voltage rise at node 33 to turn on the shunting transistor MN4. The inverters 50 and 51 can also shield node 33 from noises at node 31. Additional hysteresis circuits can be added to inverters 50 and 51 to further shield node 33 from noises at node 31.

The feedback N-MOSFET transistor MN0 turns on when node 31 is high, thus forcing the node 30 to stay low even when the current is flowing through resistor R1. The feedback P-MOSFET transistor MP0 is turned off when node 31 is high. To ensure the voltage developed at node 30 to stay low during the ESD event, the on-state resistance of the N-MOSFET transistor MN0 is designed to be smaller than the R1, for example, by a factor of 10 or larger. The feedback N-MOSFET transistor can thus keep the node 30 low and the shunting transistor on through the ESD event. Since the length of the shunting operation is no longer limited by the RC time of the RC circuit, the capacitor C1 can be made much smaller than conventional RC gate-coupled ESD protection circuit, thus allowing a reduction in the circuit area and scalability to smaller chip sizes in submicron chip technologies.

During normal operation of a device, the supply terminal 100 is powered up. Node 30 stays high, which keeps node 31 at a low voltage state through inverter 50. The low voltage state of node 31 turns off the N-MOSFET transistor MN0. The low voltage state of node 31 also turns on the feedback P-MOSFET transistor MP0, which latches node 30 to stay high, which in turn forms a negative feedback to keep node 31 high through the inverter 50. This negative feedback mechanism helps to stabilize the circuit 2 and immune to external voltage fluctuations at the supply terminals 100 and 101 when the supply terminal 100 of the device is powered up during normal device operations. Circuit 2 therefore provides more reliable performance during ESD events and in normal device operations compared conventional ESD protection circuit.

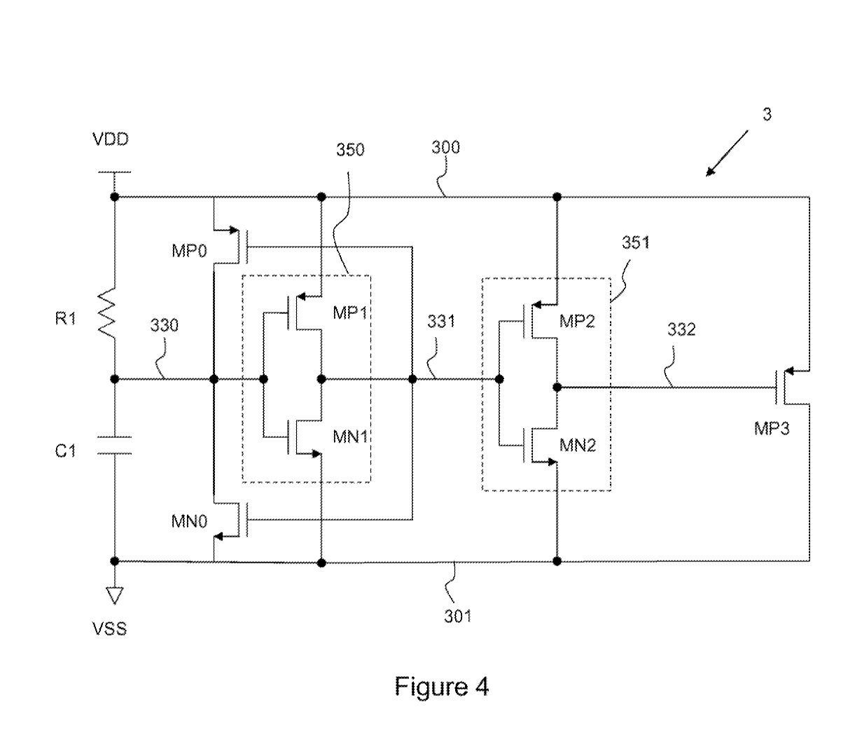

FIG. 4 illustrates a schematic diagram of an improved ESD protection circuit 3 including a P-MOSFET shunting transistor MP3, instead of the N-MOSFET shunting transistors in the convention ESD protection circuit. Similar to circuit 2, circuit 3 includes a resistor R1, a capacitor C1, and an inverter 350 including a P-MOSFET transistor MP1 and an N-MOSFET transistor MN1. The resistor R1 and the capacitor C1 are serially connected at node 330 between the supply terminals 300 and 301 that are respectively at voltages VDD and VSS. The output of the inverter 350 (i.e., node 331) is further connected with a single inverter 351. The inverter 351 includes a P-MOSFET transistor MP2 and an N-MOSFET transistor MN2. The output of the inverter 351 (i.e., node 332) is connected with the input of the shunting transistor MP3.

The circuit 3 also includes a pair of feedback transistors: a P-MOSFET transistor MP0 and an N-MOSFET transistor MN0. The gates of the transistors MP0 and MN0 are both connected with node 331, the output of the inverter 350. The transistor MP0 includes a source connected to the supply terminal 100 and a drain connected to node 330, the input of the inverter 350. The transistor MN0 includes a source connected to node 330, the input of the inverter 350 and a drain connected to the supply terminal 301.

The operations of the RC circuit, the inverter 350, and the feedback transistors MP0 and MN0 in the circuit 3 are similar to their counter parts in the circuit 2. The P-MOSFET shunting transistor MP3 is turned on when node 330 is low, node 331 is high, and node 332 is high. The feedback N-MOSFET transistor MN0 is on (MP0 if off) and keeps node 330 low so that electrostatic charges can be fully discharged.

In normal device operations, the supply terminal 300 is powered up. Node 330 is low, node 331 is high, and node 332 is high. The P-MOSFET shunting transistor MP3 is turned off. The low voltage state at node 331 turns MP0 on (MN0 is off) and keeps node 330 to stabilize at a high state.

An advantage of using a P-MOSFET shunting transistor in an ESD protection circuit, as shown in circuit 3, is that the P-MOSFET shunting transistor can provide a more uniform current distribution than the N-MOSFET transistors because hole mobility of the hole carriers used in the P-channel MOSFET transistors is much lower than electron mobility of the electron carrier used in the N-channel MOSFET transistors.

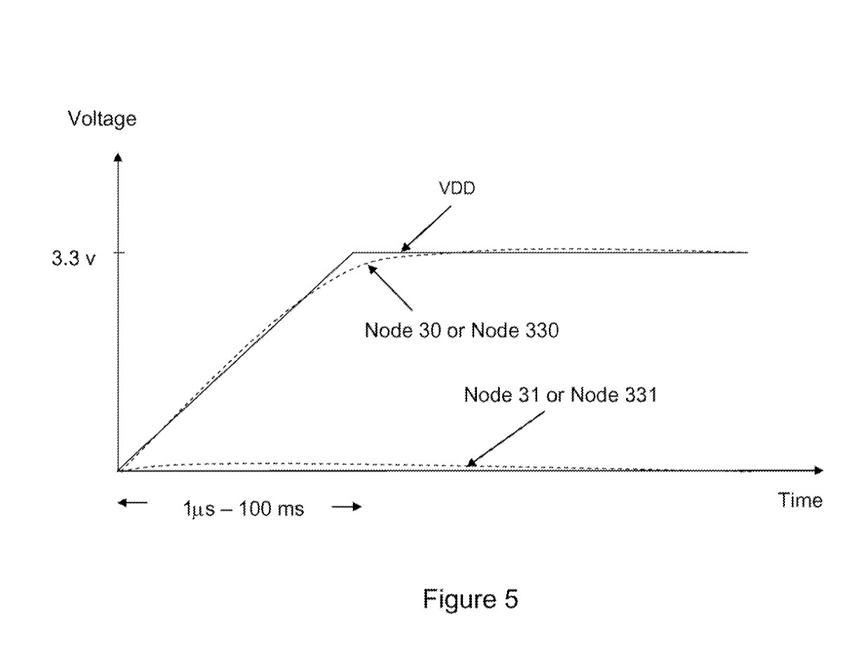

During a device power-up, referring to FIG. 5, the time for the voltage ramp up for VDD at the supply terminal can range from 1 microsecond to 100 milliseconds. The RC constants of the RC circuits 2 and 3 are designed to be small compared this time scale such that node 30 and node 330 can closely follow the VDD's rise to the normal operation voltage (e.g. 3.3 V shown in FIG. 5). The potential difference across the resistor R is kept small and not enough to trigger the transistor MP1 in the inverter 50 or 350. No discharge action is triggered at the shunting transistor MN4 in circuit 2 and the shunting transistor MP3 in circuit 3. The voltage at node 31 and node 331 are kept low, which turns on the feedback P-MOSFET transistor MP0 and further latches the node 30 or 330 to stay high.

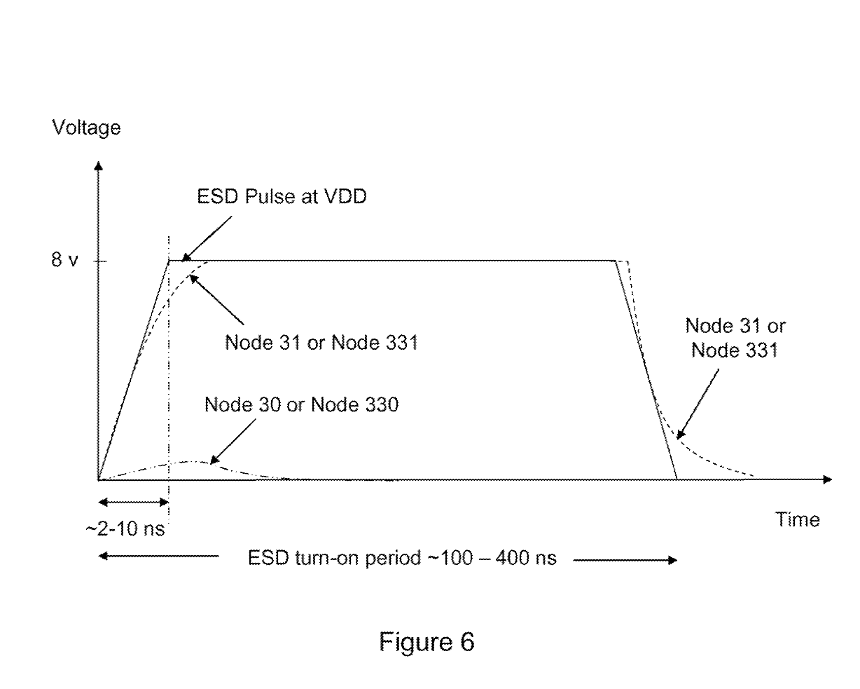

An ESD voltage pulse typically rises in much shorter time during an ESD event comparing to a device power-up. Referring to FIG. 6, a typical rise-up time for an ESD event ranges from 2 to 10 nanoseconds, which is much shorter than the RC constant of the RC circuit in the circuit 2 or the circuit 3. The comparatively long RC time means that the node 30 and 330 cannot follow VDD's rapid rise. The increased potential difference between VDD and the node 30 or 330 turns on MP1 after a few nanoseconds. The MP1 turn-on causes node 31 or 331 closely follow the ESD waveform at VDD to a peak value (e.g. 8v as shown in FIG. 6). The high voltage state node 31 or 331 turns on the feedback transistor MN0 that in turns pulls node 30 or 330 to the ground after an initial hump. After the ESD is discharged by the shunting transistor (MN4 in circuit 2 and the shunting transistor MP3 in circuit 3), the ESD voltage (VDD) decreases, which is followed by a voltage drop at the node 31 or 331 after a delay.

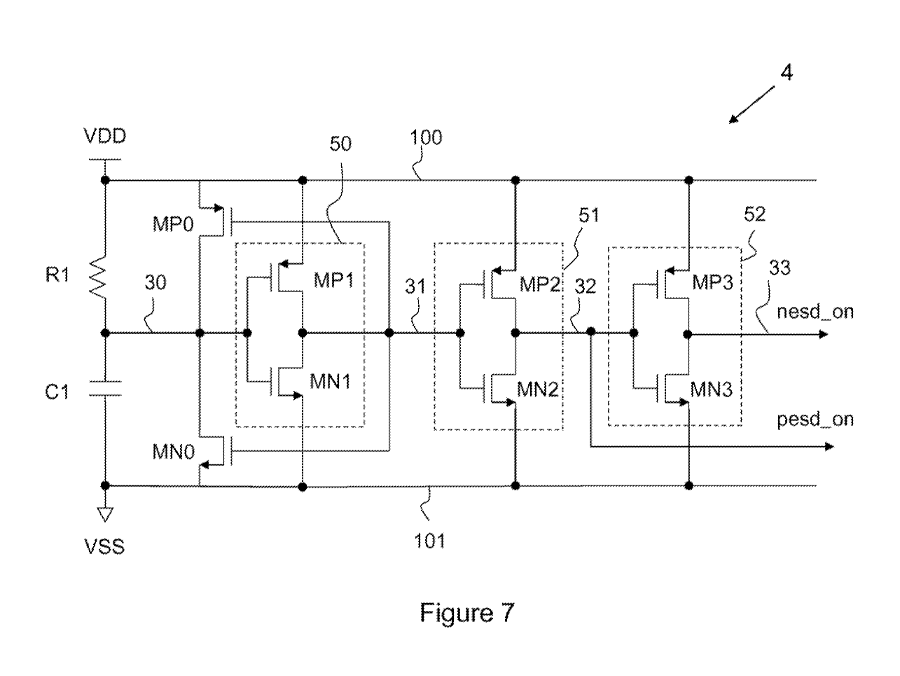

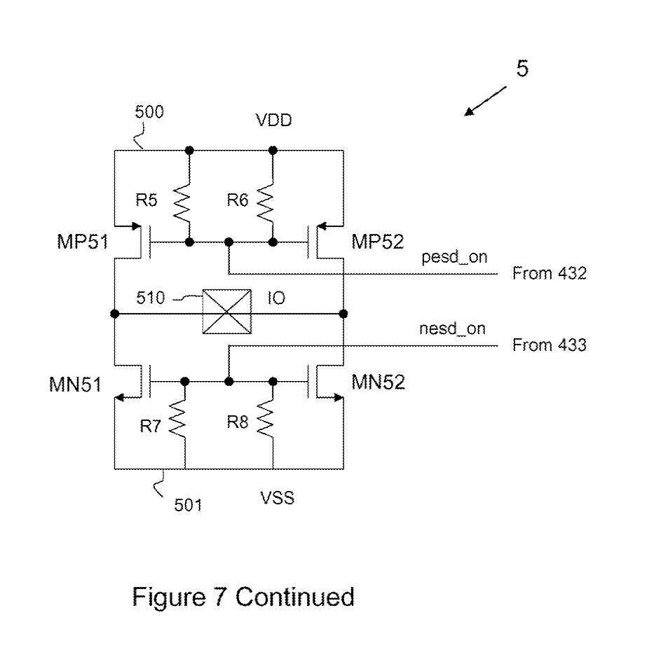

FIG. 7 illustrates an implementation of the improved ESD protection circuit 4 to a pad cell. The circuit 4 includes similar components as the circuit 2 except that the circuit 4 does not include an equivalent of the shunting transistor MN4 in circuit 2. Instead, the circuit 4 can output two signals: pesd_on at node 32 and nesd_on at node 33 to a pad circuit 5.

The pad circuit 5 includes of P-MOSFET shunting transistors MP51 and MP52, N-MOSFET shunting transistor MN51 and MN52, resistors R5, R6, R7, and R8, and the bonding pad 510. Examples of the bonding pad 510 can include common IO cell, differential driver cell, or other VDD/VSS pads. The pad circuit 5 can symmetrically designed on the left and the right sides of the bonding pad 510 (in the orientation shown in FIG. 7). The P-MOSFET shunting transistors MP51 and MP52 have their sources connected with supply terminals 500 (at voltage AVDD). The N-MOSFET shunting transistors MN51 and MN52 have their drains connected with 501 (at voltage AVSS). The signal pesd_on from node 32 is connected with the gates of the P-MOSFET shunting transistors MP51 and MP52. The signal nesd_on from node 32 is connected with the gates of the N-MOSFET shunting transistors MN51 and MN52.

The operations of circuit 4 are similar to the previously disclosures described for the circuit 2 and depicted in FIGS. 5 and 6. During an ESD event, the node 30 is kept low by the feedback transistor MN0. The node 31 and node 33 are at high voltage states. The node 32 is at a low voltage state. Thus the output signal pesd_on from node 32 is a low-voltage state signal and the output signal nesd_on from node 33 is a high-voltage state signal. The low-voltage state pesd_on signal can turn on P-MOSFET shunting transistors MP51 and MP52. The high-voltage state nesd_on signal can turn on N-MOSFET shunting transistors MN51 and MN52.

The ESD protection circuit 4 and the pad circuit 5 can protect the device from ESD zapping between any combinations among VDD, VSS and the bonding pad. If the electrostatic charges zap from VDD to IO, ESD current will be discharged from the supply terminal 500 to the bonding pad 510 through the source-drain paths of the P-MOSFET shunting transistors MP51 and MP5.

Similarly, if the electrostatic charges zap from VSS to IO, the ESD current will discharge through the source-drain paths of the N-MOSFET shunting transistors MN51 and MN52 from the supply terminal 501 to the bonding pad 510. Furthermore, if the electrostatic charges zap from VDD to VSS, the ESD current will discharge through the source-drain paths of P-MOSFET shunting transistors MP51 and MP52 and N-MOSFET shunting transistors MN51 and MN52 from the supply terminal 500 to the supply terminal 501.

If the electrostatic charges zap from IO to VDD, the ESD current passes through the parasitic diodes formed by transistors MP51 and MP52, which provides a low-voltage pesd_on signal and a high-voltage nesd_on signal. The low-voltage pesd_on signal actively turns on P-MOSFET shunting transistors MP51 and MP52, which provides a low on-resistance path between IO to VDD terminal. In this ESD protection situation, the MP51 and MP52 P-MOSFET transistors are in actively turn-on state (in which their gate nodes are low) instead of in passive turn-on states (i.e. diode).

The ESD protection circuit 4 and the pad circuit 5 have been successfully implemented in 0.35 micron process technologies. The exemplified design parameters include the following: R1 can be between about 2000 ohm to 200000 ohm, or about 20000 ohm. R1 is designed to be much larger than the on-resistance of the N-MOSFET transistor MN0. R1 can be implemented for example by high resistance poly-silicon resistor or an N-doped well resistor. C1 can be between about 0.4 pf and 40 pf, or about 4 pf. The capacitor C1 can be made of 1 to 10 units, or 4 units NMOS transistors with a unit having the dimensions of 20 micron by 20 micron. The switching threshold of the inverters 50, 51, and 52 can be pre-set to about VDD/2.

In some embodiments, the feedback P-MOSFET transistor MP0 can be built in an area approximately 60 micron by 1.5 micron. The feedback N-MOSFET transistor MN0 can be built in an area approximately 10 micron by 1.5 micron. P-MOSFET transistors MP1, MP2, MP3, MP51 or MP52 can occupy an area approximately 60 micron by 1.5 micron. N-MOSFET transistors MN1, MN2, MN3, MN51 or MN52 can occupy an area approximately 20 micron by 1.5 micron. It should be understood that the above dimensions of the transistors are presented as examples. The disclosed ESD protection circuit and pad circuit can be compatible with smaller or large transistor dimensions (for example, 20% to 80% smaller or 20% to several times larger along one of the dimensions).

An advantage of the pad circuit 5 and the ESD protection circuit 4 is that they can protect a chip device from ESD zapping between any combinations of supply terminals and bonding pad. For example, the circuits can discharge ESD zapping between another supply voltage pin AVDD in the chip device and the supply terminal VDD or VSS by simply connecting the supply voltage pin AVDD in the place of the pad 510 in the pad circuit 5. The disclosed ESD protection circuits and pad circuit are compatible with many pad configurations.

It is understood that the disclosed circuit and methods are compatible with other configurations of the electronic components and variations in circuit designs without deviation from the spirit of the present specification. Various forms of resistors, capacitors, transistors, and amplifiers can be used to achieve similar results as described above. The inverter and the feedback circuits can be based on other logic gate designs that are Boolean equivalents to what is disclosed above. The shunting transistors in the disclosed ESD protection circuit can include a P-MOSFET and N-MOSFET shunting transistors. The disclosed ESD protection circuits can also be compatible with various pad configurations such as common IO pads, singled-ended analog IO, differential-ended analog IO, crystal oscillator pad, different VDD pads and different IO pads. I can also be applied to a corner cell between VDD and VSS supply terminals inside a chip to minimize the chip area or provide ESD protection for the whole chip device.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. An electrostatic discharge protection circuit, comprising:
a first inverter;
a first transistor having a gate connected with the output of the first inverter and a drain connected with the input of the first inverter;
a second transistor having a gate connected with the output of the first inverter and a source connected with the input of the first inverter; and
a shunting transistor configured to discharge electrostatic charges between a first terminal and a second terminal in response to the output of the first inverter.

2. The electrostatic discharge protection circuit of claim 1, further comprising an RC circuit including a resistor and a capacitor, wherein the resistor and the capacitor are connected to an input to the first inverter.

3. The electrostatic discharge protection circuit of claim 2, wherein the resistor and the capacitor are serially connected, and the resistor and the capacitor are respectively connected with the first terminal and the second terminal.

4. The electrostatic discharge protection circuit of claim 1, wherein the first inverter comprises an N-MOSFET transistor and a P-MOSFET transistor.

5. The electrostatic discharge protection circuit of claim 1, further comprising a second inverter having an input connected to the output of the first inverter and an output connected to the gate of the shunting transistor.

6. The electrostatic discharge protection circuit of claim 5, wherein the shunting transistor is a P-MOSFET transistor.

7. The electrostatic discharge protection circuit of claim 1, further comprising:
a second inverter having an input connected to the output of the first inverter; and
a third inverter having an input connected to the output of the second inverter and an output connected to the gate of the shunting transistor.

8. The electrostatic discharge protection circuit of claim 6, wherein the shunting transistor is an N-MOSFET transistor.

9. An electrostatic discharge protection circuit, comprising:
an RC circuit connected with a first terminal and a second terminal, wherein the RC circuit comprises a resistor and a capacitor;
a first inverter having an input connected with the capacitor and the resistor;
a first transistor having a gate connected with the output of the first inverter and a drain or a source connected with the input of the first inverter; and
a shunting transistor configured to discharge electrostatic charges between the first terminal and the second terminal in response to the output of the first inverter.

10. The electrostatic discharge protection circuit of claim 9, further comprising a second transistor having a gate connected with the output of the first inverter and a source connected with the input of the first inverter, wherein the drain of the first transistor is connected with the capacitor and the resistor.

11. The electrostatic discharge protection circuit of claim 9, wherein the resistor and the capacitor are serially connected, and the resistor and the capacitor are respectively connected with the first terminal and the second terminal.

12. The electrostatic discharge protection circuit of claim 9, further comprising a second inverter having an input connected to the output of the first inverter and an output connected to the gate of the shunting transistor.

13. The electrostatic discharge protection circuit of claim 12, wherein the shunting transistor is a P-MOSFET transistor.

14. The electrostatic discharge protection circuit of claim 9, further comprising:
a second inverter having a input connected to the output of the first inverter; and
a third inverter having an input connected to the output of the second inverter and an output connected to the gate of the shunting transistor.

15. The electrostatic discharge protection circuit of claim 14, wherein the shunting transistor is an N-MOSFET transistor.

16. An electrostatic discharge protection circuit, comprising:
an RC circuit connected with a first terminal and a second terminal, wherein the RC circuit comprises a resistor and a capacitor;
a first inverter having an input connected with the capacitor and the resistor;
a second inverter having an input connected to the output of the first inverter;
a third inverter having an input connected to the output of the second inverter;
a first shunting transistor each having a gate connected with the output of the second inverter; and
a second shunting transistor each having a gate connected with the output of the third inverter.

17. The electrostatic discharge protection circuit of claim 16, wherein the first shunting transistor comprises a P-MOSFET transistor and the second shunting transistor comprises an N-MOSFET transistor.

18. The electrostatic discharge protection circuit of claim 16, wherein the first shunting transistor and the second shunting transistor are configured to discharge electrostatic charges between the first terminal and the second terminal.

19. The electrostatic discharge protection circuit of claim 16, wherein at lest one of the shunting transistor and the second shunting transistor comprises a drain or a source connected to a bonding pad, wherein the first shunting transistor and the second shunting transistor are configured to discharge electrostatic charges between the bonding pad and the first terminal or the second terminal.

20. The electrostatic discharge protection circuit of claim 16, further comprising:
a first transistor having a gate connected with the output of the first inverter and a drain connected with the input of the first inverter; and
a second transistor having a gate connected with the output of the first inverter and a source connected with the input of the first inverter.
